(19) United States
(12) Patent Application Publication
(10) Pub. No.: US 2025/0193252 A1
(43) Pub. Date: Jun. 12, 2025

(54) EFFICIENT REPRESENTATION OF MULTIPLE CLOUD COMPUTING ENVIRONMENTS THROUGH UNIFIED IDENTITY MAPPING

(71) Applicant: Wiz, Inc., New York, NY (US)

(72) Inventors: Avihai BERKOVITZ, Tel Aviv (IL); George PISHA, Giv'atayim (IL); Yaniv Joseph OLIVER, Tel Aviv (IL); Udi REITBLAT, Tel Aviv (IL)

(73) Assignee: Wiz, Inc., New York, NY (US)

(21) Appl. No.: 19/046,234

(22) Filed: Feb. 5, 2025

Related U.S. Application Data
(63) Continuation of application No. 17/654,668, filed on Mar. 14, 2022, now Pat. No. 12,278,840.
(60) Provisional application No. 63/222,709, filed on Jul. 16, 2021.

(51) Int. Cl. H04L 9/40

(52) U.S. Cl. CPC H04L 63/20; H04L 63/10; H04L 63/1433

(57) ABSTRACT

A system and method for generating a security graph utilizing a unified model based on multiple cloud environments are provided. The method includes receiving data from a first cloud environment pertaining to: resources, principals, and permissions; generating for each resource a corresponding resource node in the security graph, the corresponding resource node including an identifier of the resource, wherein the resource is a cloud entity deployed in the first cloud environment; generating for each principal a corresponding principal node in the security graph, the corresponding principal node including an identifier of the principal, wherein the principal is a cloud entity in the first cloud environment that generates an operation request in the first cloud environment; and generating a connection between at least a principal node and at least a resource node in the security graph, in response to detecting a permission indicating that a principal can access a resource.

### CROSS-REFERENCE TO RELATED APPLICATIONS

This application is a continuation of claims U.S. Non-Provisional application Ser. No. 17/654,668, filed Mar. 14, 2022, now allowed, which claims the benefit of U.S. Provisional Application No. 63/222,709 filed on Jul. 16, 2021, the contents of which are hereby incorporated by reference.

### TECHNICAL FIELD

The present disclosure relates generally to cybersecurity and, in particular, to techniques for multi-tenant agentless vulnerability scanning through unified identity mapping.

### BACKGROUND

As users migrate data storage, processing, and management tasks to decentralized, off-location devices, platforms, and services, the limitations of such devices, platforms, and services, also referred to as cloud environments, platforms, and the like, may impact a user's data operations. Specifically, vulnerabilities within cloud-deployed resources and processes may present unique challenges requiring remediation. Due to the scale, and structure of cloud systems, detection of workload vulnerabilities, which detection may be readily provided in non-cloud deployments, may require numerous, complex tools and operations.

Current solutions to cloud workload vulnerability scanning challenges require the deployment of specialized tools, including scanning agents directed to the maintenance of virtual machines (VMs), where operation and maintenance of such tools may be costly, time-consuming, or both. Agent-dependent processes fail to provide for scanning of containers, such as containers managed using Kubernetes®, and other, like, container-management platforms, and may fail to provide for coverage of serverless applications. Existing agent-implementation processes or solutions fail to provide for full cloud workload vulnerability scanning, additional methods, such as snapshot-based scanning, may supplement implemented solutions.

Additionally, many organizations prefer not to be constrained by a single cloud architecture and utilize cloud computing environments across multiple cloud architectures. For example, an organization may have a first cloud computing environment deployed using Google® Cloud Platform (GCP), a second cloud computing environment deployed using Amazon® Web Services (AWS), and so on.

While this allows an organization to enjoy the benefits of each different architecture, it presents a new type of management problem. Users require different user accounts, for example, to access the resources of each cloud environment. Managing user accounts and service accounts can rapidly become a complex problem, especially in a large organization that further provides access to internal resources to third party applications, vendors, and the like.

It would, therefore, be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for generating a security graph utilizing a unified model based on multiple cloud computing environments. The method comprises: receiving data from a first cloud computing environment pertaining to: a plurality of resources, a plurality of principals, and a plurality of permissions; generating for each resource of the plurality of resources a corresponding resource node in the security graph based on the unified model, the corresponding resource node including an identifier of the resource, wherein the resource is a cloud entity deployed in the first cloud computing environment; generating for each principal of the plurality of principals a corresponding principal node in the security graph based on the unified model, the corresponding principal node including an identifier of the principal, wherein the principal is a cloud entity in the first cloud computing environment that generate a request for an operation in the first cloud computing environment; and generating a connection between at least a principal node and at least a resource node in the security graph, in response to detecting a permission indicating that a principal corresponding to the at least a principal node can access a resource corresponding to the at least a resource node.

Certain embodiments disclosed herein include a non-transitory computer-readable medium having stored thereon instructions for causing a processing circuitry to perform a process for generating a security graph utilizing a unified model based on multiple cloud computing environments. The process includes: receiving data from a first cloud computing environment pertaining to: a plurality of resources, a plurality of principals, and a plurality of permissions; generating for each resource of the plurality of resources a corresponding resource node in the security graph based on the unified model, the corresponding resource node including an identifier of the resource, wherein the resource is a cloud entity deployed in the first cloud computing environment; generating for each principal of the plurality of principals a corresponding principal node in the security graph based on the unified model, the corresponding principal node including an identifier of the principal, wherein the principal is a cloud entity in the first cloud computing environment that generate a request for an operation in the first cloud computing environment; and generating a connection between at least a principal node and at least a resource node in the security graph, in response to detecting a permission indicating that a principal corresponding to the at least a principal node can access a resource corresponding to the at least a resource node.

Certain embodiments disclosed herein include a system for generating a security graph utilizing a unified model based on multiple cloud computing environments. The system comprises a processing circuitry and a memory, the memory containing instructions that, when executed by the processing circuitry, configure the system to: receive data from a first cloud computing environment pertaining to a plurality of resources and a plurality of principals of the first cloud computing environment, the data including a plurality of identifiers and a plurality of permissions; generate for each resource of the plurality of resources a corresponding resource node in a unified model graph, the corresponding resource node including an identifier of the resource; generate for each principal of the plurality of principals a corresponding principal node in the unified model graph, the corresponding principal node including an identifier of the principal; and generate a connection between at least a principal node and at least a resource node in the unified model graph, in response to detecting a permission indicating that a principal corresponding to the at least a principal node can access a resource corresponding to the at least a resource node.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, method may include receiving data from a computing environment pertaining to: a plurality of resources, a plurality of principals, and a plurality of permissions. The method may also include generating a resource representation for a resource of the plurality of resources in a security database based on an unified model, the representation including an identifier of the resource, where the resource is deployed in the computing environment. The method may furthermore include generating a principal representation for a principal of the plurality of principals in the security database based on the unified model, the principal representation including an identifier of the principal, where the principal includes a permission to initiate an action in the computing environment. The method may in addition include detecting a permission of the plurality of permissions authorizing the principal to access the resource. The method may moreover include generating a connection between the principal representation and the resource representation in the security database, in response to detecting the permission. Other embodiments of this aspect include corresponding computer systems, apparatus, and computer programs recorded on one or more computer storage devices, each configured to perform the actions of the methods.

Implementations may include one or more of the following features. The method may include: requesting the received data from an application programming interface (API) of the computing environment. The method where receiving the data further may include: reading at least one text based policy received from the computing environment, each indicating at least one permission for the principal to act on the resource. The method may include: receiving data from a second computing environment pertaining to: a plurality of resources and a plurality of principals of the second computing environment, including a plurality of identifiers and a plurality of permissions; generating a resource representation for a resource of the plurality of resources of the second computing environment; and generating a principal representation for a principal of the plurality of principals of the second computing environment, in response to determining that the principal of the second computing environment is not represented in the security database by a corresponding principal representation. The method may include: mapping a resource of the second computing environment to a resource representation in the security database, in response to determining that the resource of the a second cloud computing environment is the same as a resource already represented by the resource representation. The method where determining further may include: comparing an identifier of the resource to an identifier of the resource representation; and mapping the resource to the resource representation in response to determining that the identifier of the resource is identical to the identifier of the resource representation. The method may include: generating an entity representation in the security database; connecting a first principal representation from a first computing environment to the an entity node; and connecting a second principal representation from the second computing environment to the entity node, in response to determining that the first principal representation and the second principal representation represent a single entity. The method may include: determining that the first principal representation and the second principal representation represent a single entity by matching at least an attribute value of the first principal representation to a corresponding attribute value of the second principal representation. The method where the at least an attribute value is any one of: an username, an email address, a role, a permission, and any combination thereof. Implementations of the described techniques may include hardware, a method or process, or a computer tangible medium.

In one general aspect, a non-transitory computer-readable medium may include one or more instructions that, when executed by one or more processors of a device, cause the device to: receive data from a computing environment pertaining to: a plurality of resources, a plurality of principals, and a plurality of permissions; generate a resource representation for a resource of the plurality of resources in a security database based on an unified model, the representation including an identifier of the resource, where the resource is deployed in the computing environment; generate a principal representation for a principal of the plurality of principals in the security database based on the unified model, the principal representation including an identifier of the principal, where the principal includes a permission to initiate an action in the computing environment; detect a permission of the plurality of permissions authorizing the principal to access the resource; and generate a connection between the principal representation and the resource representation in the security database, in response to detecting the permission. Other embodiments of this aspect include corresponding computer systems, apparatus, and computer programs recorded on one or more computer storage devices, each configured to perform the actions of the methods.

In one general aspect, a system may include a processing circuitry. The system may also include a memory, the memory containing instructions that, when executed by the processing circuitry, configure the system to: . The system may furthermore receive data from a computing environment pertaining to: . The system may in addition include a plurality of resources, a plurality of principals, and a plurality of permissions. The system may moreover generate a resource representation for a resource of the plurality of resources in a security database based on an unified model, the representation including an identifier of the resource, where the resource is deployed in the computing environment. The system may also generate a principal representation for a principal of the plurality of principals in the security database based on the unified model, the principal representation including an identifier of the principal, where the principal includes a permission to initiate an action in the computing environment. The system may furthermore detect a permission of the plurality of permissions authorizing the principal to access the resource. The system may in addition generate a connection between the principal representation and the resource representation in the security database, in response to detecting the permission. Other embodiments of this aspect include corresponding computer systems, apparatus, and computer programs recorded on one or more computer storage devices, each configured to perform the actions of the methods.

Implementations may include one or more of the following features. The system where the memory contains further instructions which when executed by the processing circuitry further configure the system to: request the received data from an application programming interface (API) of the computing environment. The system where the memory contains further instructions that, when executed by the processing circuitry for receiving the data, further configure the system to: read at least one text based policy received from the computing environment, each indicating at least one permission for the principal to act on the resource. The system where the memory contains further instructions which when executed by the processing circuitry further configure the system to: receive data from a second computing environment pertaining to: a plurality of resources and a plurality of principals of the second compute environment, including a plurality of identifiers and a plurality of permissions; generate a resource representation for a resource of the plurality of resources of the second computing environment; and generate a principal representation for a principal of the plurality of principals of the second computing environment, in response to determining that the principal of the second computing environment is not represented in the security database by a corresponding principal representation. The system where the memory contains further instructions which when executed by the processing circuitry further configure the system to: map a resource of the second computing environment to a resource representation in the security database, in response to determining that the resource of the a second cloud computing environment is the same as a resource already represented by the resource representation. The system where the memory contains further instructions that, when executed by the processing circuitry for determining, further configure the system to: compare an identifier of the resource to an identifier of the resource representation; and map the resource to the resource representation in response to determining that the identifier of the resource is identical to the identifier of the resource representation. The system where the memory contains further instructions which when executed by the processing circuitry further configure the system to: generate an entity representation in the security database; connect a first principal representation from a first computing environment to the an entity node; and connect a second principal representation from the second computing environment to the entity node, in response to determining that the first principal representation and the second principal representation represent a single entity. The system where the memory contains further instructions which when executed by the processing circuitry further configure the system to: determine that the first principal representation and the second principal representation represent a single entity by matching at least an attribute value of the first principal representation to a corresponding attribute value of the second principal representation. The system where the at least an attribute value is any one of: an username, an email address, a role, a permission, and any combination thereof. Implementations of the described techniques may include hardware, a method or process, or a computer tangible medium.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a schematic illustration of multiple cloud-based computing environments communicatively connected to a unifying identity mapper, implemented in accordance with an embodiment.

FIG. 2A is a portion of a security graph using a unified model generated by the mapper and generated in accordance with an embodiment.

FIG. 2B is another portion of a security graph using a unified model generated by the mapper and generated in accordance with an embodiment.

FIG. 3 is a flowchart of a method for mapping principals and resources from a first computing environment to a security graph in accordance with an embodiment.

FIG. 4 is a flowchart of a method for determining effective permissions of a principal in a cloud environment, implemented in accordance with an embodiment.

FIG. 5 is a flowchart of a method for determining effective permissions of a resource in a cloud environment, implemented in accordance with an embodiment.

FIG. 6 is a flowchart of a method for detecting permission escalation utilizing a unified identity model implemented in a security graph, implemented in accordance with an embodiment.

FIG. 7 is a schematic illustration of a mapper, implemented according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

Organizations use multiple cloud computing environments to accomplish tasks and provide services. Each cloud computing environment may be utilized in a different manner, complicating an organization's interaction with them. The disclosure teaches providing a unified model in a security graph consisting of principals acting on resources, and methods of mapping different cloud computing environments to the unified model in the security graph. The unified model provides for a normalized view of an organization's principals and resources across various compute environments. The unified model in the security graph allows, for example, to map identities across cloud computing environments and detect permission escalations.

Some example embodiments include identity mapping to allow detection of vulnerabilities in cloud computing environments. The identity mapping may include mapping principals and resources of each cloud computing environment to a unified model, by accessing data from the environment. Mapping is further based on permissions read from the cloud computing environment. In an embodiment mapping identities includes representing each identity as a node in a security graph. Traversing the security graph allows detection of cybersecurity threats, for example, by detecting permission escalation potential between two or more principal nodes.

In order to decrease complexity of the graph, various optimizations, such as utilizing maximal biclique, are implemented when generating connections in the graph between principals and resources. The disclosed embodiments allow to decrease memory usage and processing resources, resulting in a system with increased security utilizing less resources than the currently available solutions.

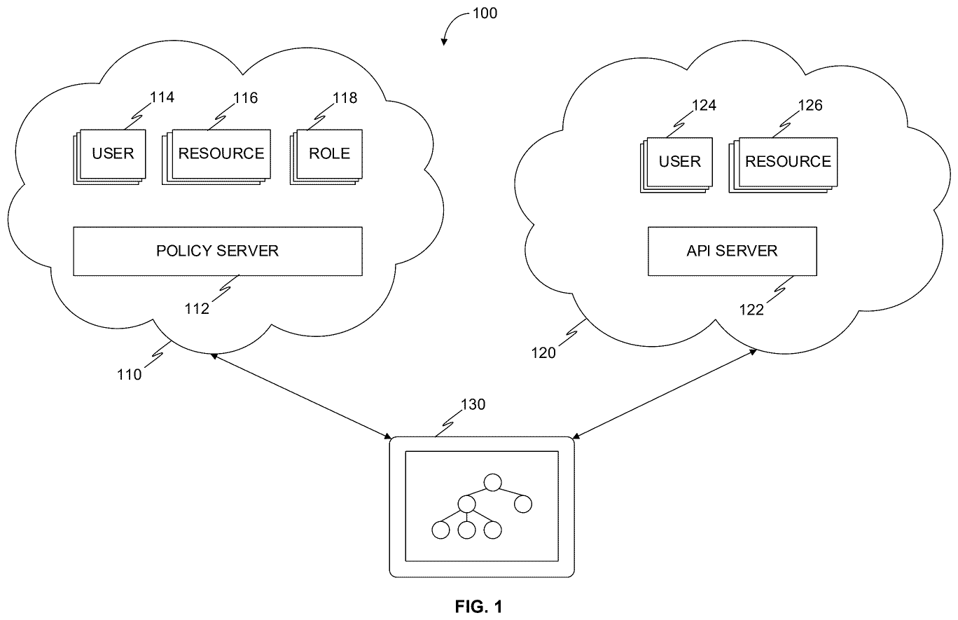

FIG. 1 is a schematic illustration 100 of multiple cloud computing environments communicatively connected to a unifying identity mapper, implemented in accordance with an embodiment. Cloud computing environments may each operate with one or more standards (i.e., models), and achieve similar or different functionality in different or similar manners. An organization of users may use a first type of cloud environment for a first purpose, where it is advantageous, and a second type of cloud environment for a second purpose, where the second environment is likewise advantageous. Amazon® Web Services (AWS), Google® Cloud Platform (GCP), and Microsoft® Azure are all examples of cloud computing infrastructures. Within such an infrastructure, an organization may have its own cloud environment, for example implemented as a virtual private cloud (VPC). For example, an organization may use AWS as a first cloud environment, and GCP as a second cloud environment. GCP may define a service account as having a first set of attributes, while AWS may define a service account as a user account having a second set of attributes, where at least a portion of the attributes of the first and second sets overlap.

However, utilizing different cloud environments may lead to complicated security policies, which in turn can present vulnerabilities for an organization. In order to at least minimize these risks, it would be beneficial to have a single normalized model for all cloud environments. Such a single normalized model would allow to identify where potential threats and risks are.

Generally, every cloud computing environment includes principals which act on resources. A principal is a cloud entity which can generate a request for an action or operation to occur in the cloud environment, where the action or operation involves a resource. In an embodiment a principal may be implemented as a cloud entity having an identifier (e.g., email address) associated with a set of permissions. A permission may allow the principal to generate service requests in the cloud environment. A principal may be a user account, service account, role, and the like, while a resource may be a virtual machine, container, serverless function, and the like. Each cloud environment may include different definitions and structures for what constitutes a principal or a resource. For example, in some cloud computing environments code may execute as a user account rather than a service account, while in others code can only execute as a service account.

As demonstrated in FIG. 1, a first type of cloud-based computing environment (hereinafter “cloud environment”) 110 includes a plurality of user accounts 114, a plurality of resources 116, and a plurality of roles 118. A role 118 is a set of one or more permissions which may be associated with one or more user accounts 114. A user account 114 may be associated with a plurality of roles. The cloud environment 110 further includes a policy server 112, which includes one or more security policies, Each security policy (or simply policy) includes one or more permissions which allow a user account 114, a role 118 or both, access to a resource 116. A policy may be, for example, a JSON file including therein text that indicates what certain permissions are. A policy may include wildcards, allowing, for example, every user account having an email address at a first domain access to a first resource, and user accounts having an email address at a second domain access to the first resource and to a second resource. For example, the first type of cloud environment may be an AWS type cloud environment.

A second type of cloud environment 120 includes a plurality of user accounts 124, a plurality of resources 126, and an API server 122. The API server 122 may provide upon request data including user accounts, applications, resources, and relationships (i.e., permissions) between them. For example, the second type of cloud environment may be a GCP type cloud environment.

Each of the cloud environments 110 and 120 are connected to a unifying identity mapper 130 over a network (not shown). A cloud environment may be, for example, Amazon® Web Services (AWS), Google® Cloud Platform, Microsoft® Azure, and the like. The first and second cloud environments 110, 120 may be the same type of cloud environment, or different types of cloud environments. For example, a first cloud environment may be spun up in AWS, while the second cloud environment is spun up in Azure. As another example, the first and second cloud environments 110, 120 may be both spun up in AWS, as separate environments under the same cloud computing architecture, e.g. utilizing a first VPC for the first cloud environment 110 and a second VPC for the second cloud environment 120.

In some embodiments, the unifying identity mapper (“mapper 130”) may reside in the first cloud environment 110, the second cloud environment 120, or a different networked or cloud computing environment. The mapper 130 is configured to receive from each cloud environment data pertaining to cloud entities, such as users, resources, roles, policies, permissions, and the like. Receiving such data may be different based on the cloud environment architecture. For example, Google® Cloud Platform provides such information by accessing an API, which may be queried to receive text based policies, a list of user accounts, a list of service accounts, a combination thereof, and the like.

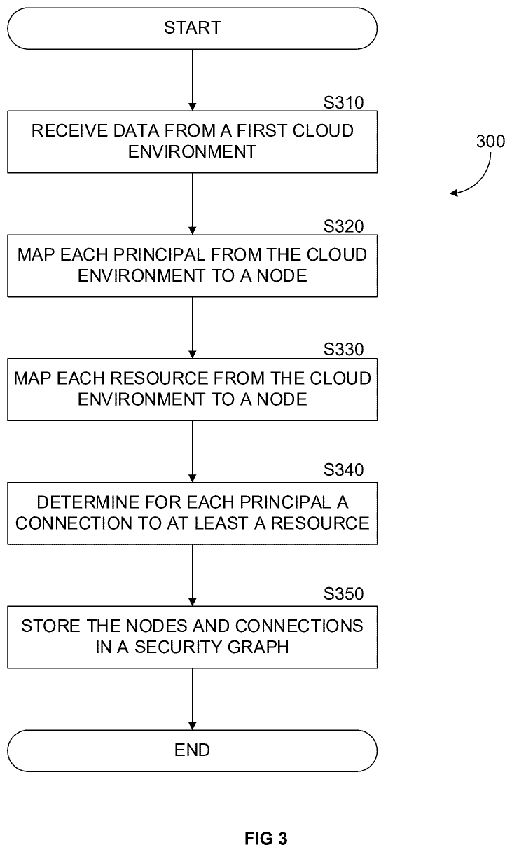

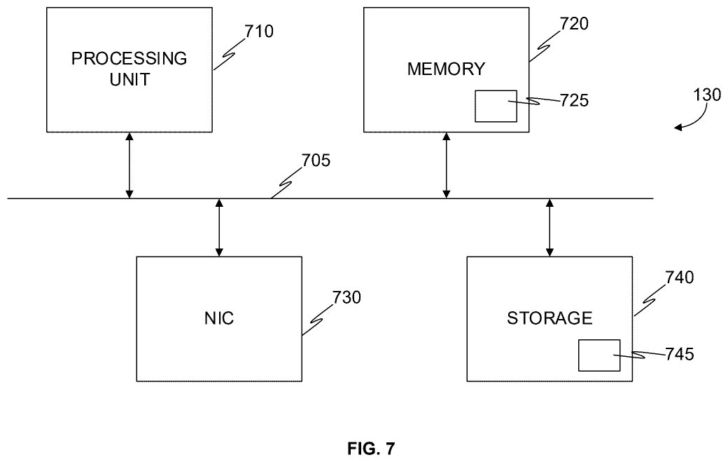

In an embodiment, the mapper 130 is configured to call the API with a request to receive the data. As another example, AWS provides policies which may be requested as JSON files. The mapper 130 is further configured to read the data from, for example, the JSON file and map the read (or received) data into a unified model of a security graph. Mapping the received data may include generating nodes in a security graph representing principals and resources, and connecting the nodes based on permissions which are read from the received data. This is discussed in more detail in FIG. 3 herein. The security graph may be stored in a graph database. A graph database may be, for example, Neo4j®. The mapper 130 may be implemented as a physical machine, a virtual machine, a node of a container, and the like. An embodiment of a mapper 130 is discussed in more detail in FIG. 7 below.

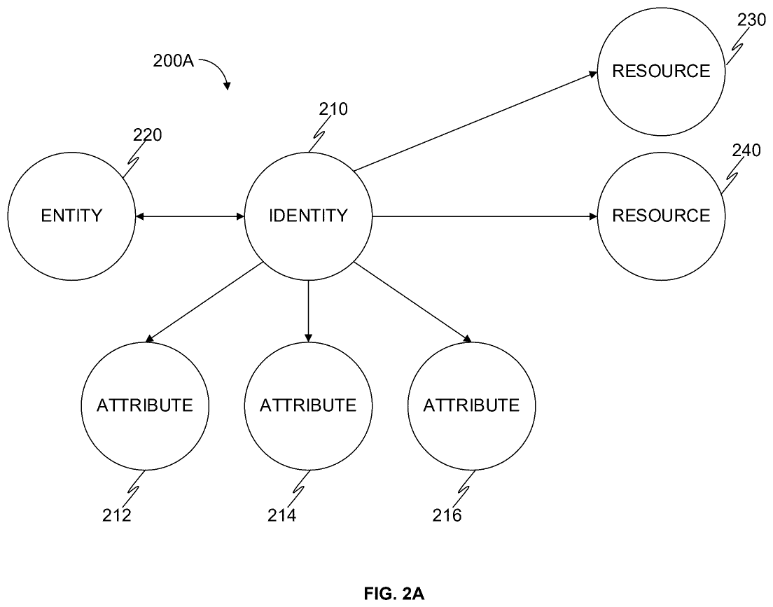

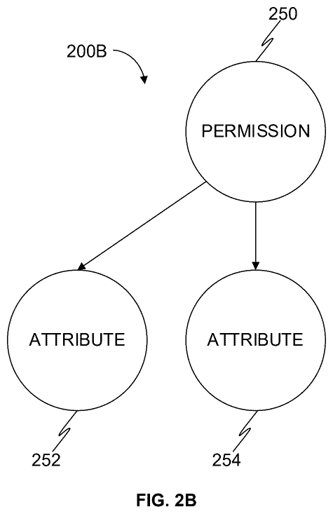

FIG. 2A is a portion of a security graph using a unified model 200A generated by the mapper 130 and generated in accordance with an embodiment. An identity is an example of a principal, which acts on resources, such as first resource 230 and second resource 240. In an embodiment, an identity is a set of attributes stored as digital information which represent a principal. An identity 210, such as a username, may be associated with an entity 220. The entity 220 may be a person, organization, application, device, machine, and so on.

Each identity 210 may be connected to a plurality of attributes, such as a first attribute 212, a second attribute 214, and third attribute 216. While three attributes are used in this example, it is readily understood that any number of attributes may define an identity node, and that each identity node may be defined by one or more attributes. An attribute may be metadata. For example, a role may be an attribute of an identity node.

FIG. 2B is another portion of a security graph using a unified model 200B generated by the mapper 130 and generated in accordance with an embodiment. A permission node 250 is connected with a first attribute node 252, and a second attribute node 254. While two attributes are used in this example, it is readily understood that any number of attributes may define a permission node 250, and that each permission node may be defined by one or more attributes. An attribute of a permission node 250 may indicate different permission types, such as reading, writing, or erasing files, agents, administrator or root roles, and the like. A permission node 250 may be connected to an identity node, such as the identity node 210 of FIG. 2A.

FIG. 3 is an example flowchart 300 of a method for mapping principals and resources from a first computing environment to a security graph in accordance with an embodiment. In an embodiment, the method is performed by the unified identity mapper 130, FIG. 1.

At S310, data is received from at least a first cloud environment. In certain embodiments, data may be received from a plurality of first cloud environments. In some embodiments, data may be further received from a second cloud environment. The second cloud environment may be different from the first cloud environment. For example, the first cloud environment may be an AWS-type cloud environment, while the second cloud environment may be an Azure-type cloud environment. Data may include any information relating to principals, resources, and connections between principals and resources. For example, data may be received by querying an API of a cloud environment to receive user account information, service account information, policies, and the like.

A principal is a cloud entity which can generate a request for an action or operation to occur in the cloud environment, where the action or operation involves a resource. In an embodiment a principal may be implemented as a cloud entity having an identifier (e.g., email address) associated with a set of permissions. A permission may allow the principal to generate service requests in the cloud environment. A principal may be a user account, service account, role, and the like. For example, a role is a set of one or more permissions which may be associated with one or more user accounts. Permissions may be defined, for example, by a policy. A policy may be, for example, a JSON file including therein text which indicates what certain permissions are.

A resource is a cloud entity which includes compute elements, such as storage, memory, parallel processor, linear processor, a combination thereof, and the like. In an embodiment a resource may be, for example, a virtual machine, a container, a serverless function, a bucket, a WAF (Web Application Firewall), a gateway, a proxy server, an application, an appliance, a database, and the like.

At S320, each principal from the first cloud environment is mapped to a corresponding principal node of a security graph using a unified model. In an embodiment, this is performed by generating the principal node in the security graph based on the unified model and associating the principal node with the principal (e.g., associating the principal node with an identifier of the principal). In an embodiment a unified model is a data structure template including a plurality of principal attributes, such that a data structure may be generated for each principal, and at least a portion of the plurality of attributes may have values generated based on attributes of the principal.

A principal node may be, for example, an identity node. For example, a user account is a principal, and the user account is mapped to a principal node representing the user account. The security graph may further store as attributes metadata associated with the user account, such as a username, account type, role, and the like. In an embodiment, a principal from a first cloud environment and a principal from a second cloud environment may be each mapped to a corresponding first and second principal nodes. The first and second principal nodes may be connected to an entity node. This may indicate, for example, that a single entity (e.g., human user) is associated with a user account represented by the first principal node, and a user account represented by the second principal node. Connecting the first and second principal nodes to the entity node may be based on performing a match between attribute values. An attribute may be, for example, a username, email address, role (e.g., admin, root, etc.), and the like. A resource such as a serverless function, is mapped to a resource node representing the serverless function. The security graph may further store for the resource node metadata such as IP address, name, etc.

At S330, each resource from the first cloud environment is mapped to a corresponding resource node of the unified model of the security graph. In an embodiment, this is performed by generating the resource node and associating it with the resource (e.g., associating the resource node with a unique identifier of the resource). The generated nodes may include information that points to the identity/resource to which they are mapped, thereby enabling a trace between the representation (e.g., principal node) and the represented object (specific username). In some embodiments, an entity in a cloud environment may be a principal, and also a resource to other principals. For example, a load balancer may be a resource for a user account, but a principal for a web server which utilizes the load balancer.

At S340 a connection is determined for each principal node to at least another node. The at least another node may be a resource node, or another principal node, such as a role node. A role node is associated with a specific role (i.e., set of one or more permissions relating to a resource). In an embodiment, the connection to a principal node is determined based on a permission allowed to the principal node. In an embodiment, determining a connection may include reading data from a security policy in order to determine if a permission exists to allow communication between the principal node and another principal node, a resource node, a combination thereof, and the like.

At S350 the nodes and connections are stored in the security graph. Storing the nodes and connections (also referred to as edges) in the security graph may include generating in the security graph a data structure based on a template of a unified model, and updating a graph database containing therein the security graph based on the generated data structure. A template may include data attributes. In an embodiment, the unified model includes a plurality of templates, each template corresponding to a cloud entity.

A unified model is useful, for example, for normalizing different cloud infrastructures, which may represent principals, resources, and the like in different ways. For example, a user account may be implemented utilizing different technology stacks in AWS or GCP, especially when considering associating permissions, roles, policies, and the like, with a user account. By representing all user accounts using a unified data structure in a security graph, a user querying the graph can get visibility into an organization's entire technology stack, regardless of what cloud infrastructures are used to implement it. Additionally, the methods disclosed herein provide for populating this unified model from multiple cloud environments in an efficient manner in terms of computation (i.e., processor) use, memory use, and storage use. Another advantage of storing a representation of multiple cloud environments using a unified model according to the teachings herein is in allowing to store a single representation (i.e., single graph for all cloud environments) rather than store multiple representations in multiple different systems. Therefore, memory and storage are utilized in a more efficient manner.

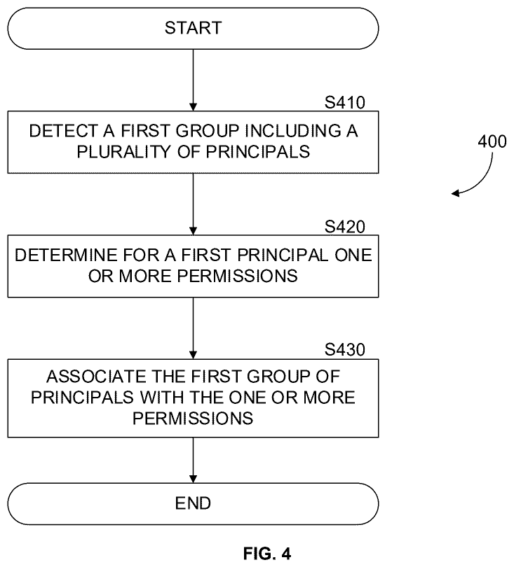

FIG. 4 is an example flowchart 400 of a method for determining effective permissions of a principal in a cloud environment, implemented in accordance with an embodiment. Effective permissions are permissions which a principal has in the cloud environment in which the principal is deployed. The permissions may include a set of actions and operations which the principal can instruct the cloud environment, or one or more resources of the cloud environment, to perform. Determining effective permissions is advantageous from a security perspective as it allows to realistically understand where potential security threats may arise. For example, assuming a certain user has limited permissions, only to discover that the user has permissions which exceed those limitations, is a typical scenario in cybersecurity incidents (e.g., limited third party vendor having administrator permissions).

A naïve approach for determining effective permission would be to determine for each principal represented in the security graph each possible interaction with each resource. However, for typical cloud environments, this can lead to large and complicated calculations, thus requiring large compute and memory resources to accomplish, and in most cases, it is not a feasible solution. An optimization is therefore proposed.

At S410, a first group of a plurality of principals is detected in a security graph. Detecting a group of principals may be performed, for example, by utilizing maximal bicliques. A biclique is a bipartite graph where every node of the first set (principals) is connected to every node of the second set (resources). A biclique is maximal when it is the largest size, based on number of nodes or number of edges. The security graph may be generated, for example, as detailed in FIG. 3 above. A group of principals may be detected, for example by querying the security graph to detect all users belonging to a certain role, belonging to a certain group, having a specific permission directed at a specific resource (e.g., allowed to write to a first database), and the like.

At S420, one or more permissions are determined for a first principal of the first group. The one or more permissions may be associated with one or more resources. For example, a first permission set (i.e., role) may be associated with a first resource, a second permission set may be associated with a second resource, and so on. In an embodiment, determining the one or more permissions may be performed by querying the security graph to determine what nodes of roles, permissions, policies, and the like, a principal node representing the first principal is connected to.

At S430, the first group of principals is associated with the determined one or more permissions. By associating all the principals based on determining permissions for a single principal, many redundant calculations are spared, thereby reducing compute and memory required for storing the redundant information. For example, a node representing the determined one or more permissions (permission node) may be generated in the security graph. Nodes representing the first group of principals may be connected to the permission node, thereby associating the first group of principals with the permissions. This approach means permissions do not have to be determined for each and every principal, resulting in less processing. Further, by representing permissions as a node, the graph is more compact as less memory is used, since redundant data (i.e., repeating permissions) is not stored.

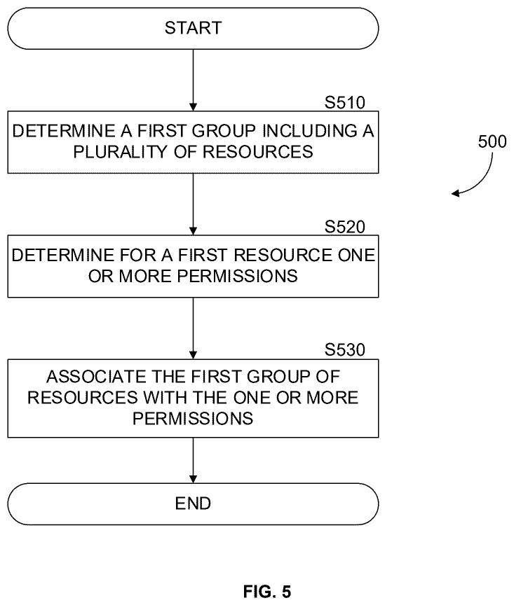

FIG. 5 is an example flowchart 500 of a method for determining effective permissions of a resource in a cloud environment, implemented in accordance with an embodiment. Determining effective permissions is advantageous from a security perspective as it allows to realistically understand where potential security threats may arise. For example, assuming a certain resource may be supposed to have limited permissions, however, the resource can assume a role which would allow the resource additional permissions which were not intended.

As stated above, a naïve approach would be to determine for each resource in the graph each possible interaction with each principal and resource. However, for typical cloud environments, this can lead to a large and complicated calculations, thus requiring large compute and memory resources to accomplish, and in most cases, it is not a feasible solution. An optimization is therefore proposed.

At S510, a first group of a plurality of resources is detected in a security graph. Detecting a group of resources may likewise be performed, for example, by utilizing maximal bicliques. As noted above, a biclique is a bipartite graph where every node of the first set (principals) is connected to every node of the second set (resources). A biclique is maximal when it is the largest size based on number of nodes or number of edges.

At S520, one or more permissions are determined for a first resource of the first group. In an embodiment, a permission is determined for a first resource by performing a search of one or more policies to detect a policy which is applied to the first resource. A policy may include a permission (e.g., ability to write to the resource) and a condition specifying what principal(s) or principal type (e.g., role) may utilize the permission. The one or more permissions may be associated with one or more resources or principals. For example, a first permission set (i.e., role) may be associated with a first resource, a second permission set may be associated with a second resource, and the like.

A permission may be, for example, permission to read data from a storage, and permission to write data to the storage. For example, a first group may have permission to read from the storage, while a second group may have permissions to read and write to the storage. As another example, a user may have permission to write to a first storage of a distributed storage system, which includes multiple storage devices. As the multiple storage devices share a common policy, the user has permission to write to any of the multiple storage devices. By grouping the storage devices, less memory is required to indicate that the user account has permission to write to any of the multiple storage devices.

At S530, the first group of resources is associated with the determined one or more permissions. By associating all the resources based on determining permissions for a single resource, many redundant calculations are spared, thereby reducing compute and memory required for storing the redundant information. For example, the first resource 230 and second resource 240 of FIG. 2A may be associated with permissions based on permissions determined for the first resource 230. A permission node may be generated in the security graph, and the first resource node 230 and second resource node 240 may be connected to the permission node.

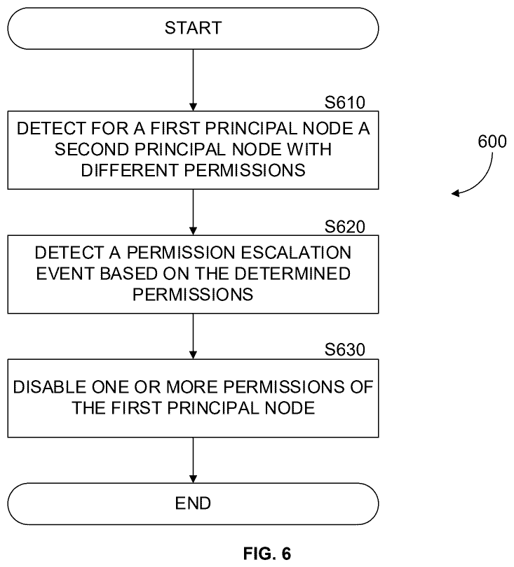

FIG. 6 is an example flowchart 600 of a method for detecting permission escalation utilizing a unified identity model implemented in a security graph, implemented in accordance with an embodiment. Permission escalation is a type of security risk where a principal has access to resources which they are not intended to have. A vertical escalation occurs when a principal is able to access resources which are only accessible to principals having higher access. A horizontal escalation occurs when a principal has access to resources of another similar principal (e.g., user A is able to access emails of user B).

At S610, a second principal node is detected for a first principal node. The first principal node is able to assume the second principal node. That is, the first principal node may act as the second principal nodes, in some, or all aspects, meaning the first principal node may request actions or generate instructions which are not permitted to the first principal, but are permitted to the second principal. Permissions of a node may change when acting through another. For example, an application may have permission to perform a wide variety of operations in a cloud environment. However, a user account operating the application may only access limited permissions of all the permissions available to the application.

At S620, a permission escalation event is detected based on determined permissions of the first principal node and the second principal node. In an embodiment, detecting a permission escalation event may occur when an access occurs which involves a principal which is not authorized for the access. This detection is possible by tracing the connection between the access and the principal, utilizing the security graph (e.g., traversing the graph between nodes) as described above.

At S630, upon detection of permission escalation events, one or more permissions associated with the principal may be revoked to prevent the escalation. In another embodiment, a notification may be generated to an administrator account to notify that a potential permission escalation may occur.

FIG. 7 is an example of a schematic illustration of the mapper 130 implemented according to an embodiment. The mapper may be a physical or virtual machine. The mapper 130, when realized as a physical machine, includes at least one processing element 710, for example, a central processing unit (CPU). In an embodiment, the processing element 710 may be, or be a component of, a larger processing unit implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing element 710 is coupled via a bus 705 to a memory 720. The memory 720 may include a memory portion 725 that contains instructions that when executed by the processing element 710 performs the method described in more detail herein. The memory 720 may be further used as a working scratch pad for the processing element 710, a temporary storage, and others, as the case may be. The memory 720 may be a volatile memory such as, but not limited to random access memory (RAM), or non-volatile memory (NVM), such as, but not limited to, Flash memory.

The processing element 710 may be coupled to a network interface controller (NIC) 730, which provides connectivity to one or more cloud computing environments, via a network.

The processing element 710 may be further coupled with a storage 740. Storage 740 may be used for the purpose of holding a copy of the method executed in accordance with the disclosed technique. The storage 740 may include a storage portion 745 containing a graph model into which principals and resources of a cloud environment are mapped to corresponding nodes, and connections between the nodes are determined based on data received from the cloud environment indicating permissions of each principal to act on one or more resources.

The processing element 710 and/or the memory 720 may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described in further detail herein.

The various embodiments disclosed herein can be implemented as hardware, firmware, software, or any combination thereof. Moreover, the software is preferably implemented as an application program tangibly embodied on a program storage unit or computer-readable medium consisting of parts, or of certain devices and/or a combination of devices. The application program may be uploaded to, and executed by, a machine comprising any suitable architecture. Preferably, the machine is implemented on a computer platform having hardware such as one or more central processing units (CPUs), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform, such as an additional data storage unit and a printing unit. Furthermore, a non-transitory computer-readable medium is any computer-readable medium except for a transitory propagating signal.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for generating a security database utilizing a unified model of a computing environment, comprising:
receiving data from a computing environment pertaining to: a plurality of resources, a plurality of principals, and a plurality of permissions;
generating a resource representation for a resource of the plurality of resources in a security database based on a unified model, the representation including an identifier of the resource, wherein the resource is deployed in the computing environment;
generating a principal representation for a principal of the plurality of principals in the security database based on the unified model, the principal representation including an identifier of the principal, wherein the principal includes a permission to initiate an action in the computing environment;
detecting a permission of the plurality of permissions authorizing the principal to access the resource; and
generating a connection between the principal representation and the resource representation in the security database, in response to detecting the permission.

2. The method of claim 1, further comprising:
requesting the received data from an application programming interface (API) of the computing environment.

3. The method of claim 1, wherein receiving the data further comprises:
reading at least one text based policy received from the computing environment, each indicating at least one permission for the principal to act on the resource.

4. The method of claim 1, further comprising:
receiving data from a second computing environment pertaining to: a plurality of resources and a plurality of principals of the second computing environment, including a plurality of identifiers and a plurality of permissions;
generating a resource representation for a resource of the plurality of resources of the second computing environment; and
generating a principal representation for a principal of the plurality of principals of the second computing environment, in response to determining that the principal of the second computing environment is not represented in the security database by a corresponding principal representation.

5. The method of claim 4, further comprising:
mapping a resource of the second computing environment to a resource representation in the security database, in response to determining that the resource of the second computing environment is the same as a resource already represented by the resource representation.

6. The method of claim 5, wherein determining further comprises:
comparing an identifier of the resource to an identifier of the resource representation; and
mapping the resource to the resource representation in response to determining that the identifier of the resource is identical to the identifier of the resource representation.

7. The method of claim 4, further comprising:
generating an entity representation in the security database;
connecting a first principal representation from a first computing environment to the entity representation; and
connecting a second principal representation from the second computing environment to the entity node, in response to determining that the first principal representation and the second principal representation represent a single entity.

8. The method of claim 7, further comprising:
determining that the first principal representation and the second principal representation represent a single entity by matching at least an attribute value of the first principal representation to a corresponding attribute value of the second principal representation.

9. The method of claim 8, wherein the at least an attribute value is any one of: a username, an email address, a role, a permission, and any combination thereof.

10. A non-transitory computer-readable medium storing a set of instructions for generating a security database utilizing a unified model of a computing environment, the set of instructions comprising:
one or more instructions that, when executed by one or more processors of a device, cause the device to:
receive data from a computing environment pertaining to:
a plurality of resources, a plurality of principals, and a plurality of permissions;
generate a resource representation for a resource of the plurality of resources in a security database based on a unified model, the representation including an identifier of the resource, wherein the resource is deployed in the computing environment;
generate a principal representation for a principal of the plurality of principals in the security database based on the unified model, the principal representation including an identifier of the principal, wherein the principal includes a permission to initiate an action in the computing environment;
detect a permission of the plurality of permissions authorizing the principal to access the resource; and
generate a connection between the principal representation and the resource representation in the security database, in response to detecting the permission.

11. A system for generating a security database utilizing a unified model of a computing environment comprising:
a processing circuitry;
a memory, the memory containing instructions that, when executed by the processing circuitry, configure the system to:
receive data from a computing environment pertaining to:
a plurality of resources, a plurality of principals, and a plurality of permissions;
generate a resource representation for a resource of the plurality of resources in a security database based on a unified model, the representation including an identifier of the resource, wherein the resource is deployed in the computing environment;
generate a principal representation for a principal of the plurality of principals in the security database based on the unified model, the principal representation including an identifier of the principal, wherein the principal includes a permission to initiate an action in the computing environment;
detect a permission of the plurality of permissions authorizing the principal to access the resource; and
generate a connection between the principal representation and the resource representation in the security database, in response to detecting the permission.

12. The system of claim 11, wherein the memory contains further instructions which when executed by the processing circuitry further configure the system to:
request the received data from an application programming interface (API) of the computing environment.

13. The system of claim 11, wherein the memory contains further instructions that, when executed by the processing circuitry for receiving the data, further configure the system to:
read at least one text based policy received from the computing environment, each indicating at least one permission for the principal to act on the resource.

14. The system of claim 11, wherein the memory contains further instructions which when executed by the processing circuitry further configure the system to:
receive data from a second computing environment pertaining to:
a plurality of resources and a plurality of principals of the second compute environment, including a plurality of identifiers and a plurality of permissions;
generate a resource representation for a resource of the plurality of resources of the second computing environment; and
generate a principal representation for a principal of the plurality of principals of the second computing environment, in response to determining that the principal of the second computing environment is not represented in the security database by a corresponding principal representation.

15. The system of claim 14, wherein the memory contains further instructions which when executed by the processing circuitry further configure the system to:
map a resource of the second computing environment to a resource representation in the security database, in response to determining that the resource of the second computing environment is the same as a resource already represented by the resource representation.

16. The system of claim 15, wherein the memory contains further instructions that, when executed by the processing circuitry for determining, further configure the system to:
compare an identifier of the resource to an identifier of the resource representation; and
map the resource to the resource representation in response to determining that the identifier of the resource is identical to the identifier of the resource representation.

17. The system of claim 14, wherein the memory contains further instructions which when executed by the processing circuitry further configure the system to:
generate an entity representation in the security database;
connect a first principal representation from a first computing environment to the entity representation; and
connect a second principal representation from the second computing environment to the entity node, in response to determining that the first principal representation and the second principal representation represent a single entity.

18. The system of claim 17, wherein the memory contains further instructions which when executed by the processing circuitry further configure the system to:
determine that the first principal representation and the second principal representation represent a single entity by matching at least an attribute value of the first principal representation to a corresponding attribute value of the second principal representation.

19. The system of claim 18, wherein the at least an attribute value is any one of:
a username, an email address, a role, a permission, and any combination thereof.
